(19) United States
(12) Patent Application Publication
(10) Pub. No.: US 2008/0200137 A1
(43) Pub. Date: Aug. 21, 2008

(54) Program Diversity

(76) Inventors: Thomas Adam, Bad Urach (DE); Christian Schwarz, Metzingen (DE); Markus Lausterer, Neuffen (DE); Frank D'Argent, Altbach (DE)

Correspondence Address: K.F. ROSS P.C., 5683 RIVERDALE AVENUE, SUITE 203 BOX 900, BRONX, NY, 10471-0900, US

(21) Appl. No.: 11/795,568

(22) PCT Filed: Dec. 9, 2005
(86) PCT No.: PCT/EP05/13189

§ 371 Date: Mar. 10, 2008

(30) Foreign Application Priority Data
Jan. 18, 2005 (DE) 10 2005 002 425.4
Aug. 20, 2005 (DE) 10 2005 039 507.4

(51) Int. Cl. H04N 5/50; H04B 1/18

(52) U.S. Cl. 455/161.3

(57) ABSTRACT

A method for receiving high frequency signals, wherein several receiver antennas receive said signals and transmit the signals of one antenna to a receiver, representing a selectable program content. It is possible to select at least one other antenna which received signals with the same program content but with better signal properties. According to the invention, the signals received by at least one antenna are examined for the data content thereof and it is possible to switch from one signal received by an antenna to another signal received by an antenna if the data content of one signal corresponds to the data content of the other signal or if, when the signals received by at least two antennas are examined for the data content thereof, it is possible to switch to another signal received by another antenna if the data content of the signal that is received by one antenna corresponds to the content of the other signal received by another antenna.

The invention relates to a method and an apparatus for receiving high-frequency signals via an antenna or a plurality of antennas in accordance with the features of the preamble of each of the independent patent claims.

Diversity methods and apparatus are known for mobile reception of high-frequency signals, in particular for signal reception in vehicles. When receiving high-frequency analog signals, which contain in particular television programs, using a diversity receiver, during reception of a television program it is possible to switch automatically between different frequencies with identical program content (same transmitter). Such a reception method makes possible continuous reception and tracking of a television program while the vehicle travels through different broadcast zones, where within one broadcast zone a transmitter is present that broadcasts the television program at a certain frequency, the frequency of the one broadcast zone being different from the broadcast frequency of one or a plurality of other broadcast zones. This method, in which the receiver can receive one and the same transmitter at a certain frequency and furthermore on other frequencies from different broadcast zones, is known and is called frequency diversity. If the vehicle leaves one-broadcast zone in which a certain transmitter broadcasts at a certain frequency, the reception properties deteriorate, and as a result when transitioning from the one broadcast zone to another broadcast zone the signal properties of the other broadcast zone improve so that this is used as a criterion for receiving the transmission no longer on the previous frequency, but rather on the other frequency that can be received better. This means that when transitioning from one broadcast zone to another broadcast zone the switching criterion from the one frequency to the other frequency of a transmitter with the same program content are the signal properties.

In addition to broadcasting analog television programs and the corresponding analog reception of broadcast programs, in particular in Europe also high-frequency digital signals are broadcast that are received by appropriately constructed receivers. These high-frequency digital signals are also broadcast from transmitters located in one broadcast zone so that in this case as well when receiving these high-frequency digital signals during transition from one broadcast zone to another broadcast zone it is necessary to retain the transmitter (with the same program content), but to switch from a transmitter whose signals were previously received to another transmitter to now receive the signals. During the transition from one digital transmitter to the next digital transmitter, the criterion “signal property” is also used as a switching criterion. In addition, other criteria can also be used, such as bit error rate.

In addition to broadcast zones in which only high-frequency analog signals or only purely high-frequency digital signals are transmitted, when there is a change in the broadcast zone due to the movement of the vehicle, it can also happen that there is a change from an analog to a digital broadcast zone or vice versa.

The underlying object of the invention is therefore to provide a method and an apparatus for receiving high-frequency signals in vehicles whereby during a change from one broadcast zone to another broadcast zone the currently received program content is retained and the change automatically occurs rapidly and without being perceived.

This object is attained using the features of the independent patent claims.

In accordance with the method the signals received from the at least one antenna are examined for their data content and then there is a switch from one signal received with the antenna to another signal received with the antenna if the data content of the one signal corresponds to the data content of the other signal. This method is used if only one antenna is available for receiving the signals (no diversity system).

Alternatively or in addition thereto it is provided that the signals received by at least two antennas are examined for their data content and then there is a switch from a signal received with the one antenna to a different signal received with the one other antenna if the data content of the one signal received with the one antenna corresponds to the data content of the other signal received with the other antenna. This method is used when more than only one antenna (e.g. two, three, four, or more than four antennas) are available for receiving the signals (diversity system).

The use of the data content of the received signals, especially when receiving television signals in moving vehicles, has the advantage that these data content represent a certain program broadcast by a stationary transmitter, regardless of whether this program is broadcast in an analog or digital format by the stationary transmitter. If it is now determined that the program that previously was received via a first antenna is received better via at least one other antenna, especially during transition from one broadcast zone to another broadcast zone, the signals received with the other antenna are fed to the receiver for processing and reproduction. Here it is important that the switch is made to an antenna with which a program having the same data content is received. The examination for corresponding data content of the individual signals that are received with the individual antennas has the advantage that these data content can be examined very rapidly, e.g. by means of a set-point/actual-value comparison, for agreement or deviation. If there is agreement (given better signal properties), there can be a switch to the other antenna. If there is not agreement, the prior transmitter can continue to be received via the first antenna, specifically until another antenna has the same program content but better signal properties. For the sake of completeness it should be mentioned that the term “first antenna” encompasses one or a plurality of antennas and the vehicle can have at least two or even more antennas that continuously receive the high-frequency signals that are then examined and compared by the downstream receiver (in particular a diversity processor) for their program contents (data content) and signal properties.

The property of the signals is the signal contents or quality using established bit error rates.

In one embodiment of the invention the data content of the received signals is determined using data from the blanking interval (VBI, vertical blanking interval). In the blanking interval there is much data that can be used such as for instance videotext, data lines, and test lines.

In one further development of the invention, the data content is determined using the name of the transmitter broadcast and received. This functions particularly well especially in the case of digitally broadcast programs in which the high-frequency digital signals also contain the name of the broadcast transmitter (e.g. ARD). If such a transmitter was received previously and if the vehicle moves into a broadcast zone in which the same transmitter is broadcast, this is detected and due to the agreement there is a switch to the antenna with the transmitter that has the same program content and that is better received.

In one further development of the invention, the data content is determined using EPG data (electronic program guide data) or SI data (service information data) or PSI data (program specific information), so that agreement or deviation can be determined-based on these data or data content.

Moreover, it is conceivable according to the invention that even more criteria can be used for determining the data content in order to be able to switch confidently from one transmitter in one broadcast zone to another transmitter that is in another broadcast zone and that has the same program content.

In terms of an apparatus, an apparatus is claimed that is characterized by its construction and suitability for performing the method. Such an apparatus includes for instance a plurality of antennas that are arranged in a vehicle. These antennas are connected to a diversity processor, which itself is connected to a receiver, the receiver assuming the processing of the received high-frequency signals and depicting the latter in a suitable manner (e.g. visually and/or acoustically). The diversity processor is constructed to switch from the one antenna to the other antenna if it receives a corresponding signal. In accordance with the invention this entire apparatus is now embodied such that the diversity processor switches from one antenna to another antenna if the processor itself, or where necessary the receiver or other devices, has examined the data content of the received high-frequency signals to determine whether there are identical program contents. If, for a plurality of antennas, but at least two antennas, there are identical program contents that differ from one another in terms of their signal properties, the diversity processor connects the antenna that has the better signal properties to the receiver.

The following description and figures further explain the invention but do not limit the invention.

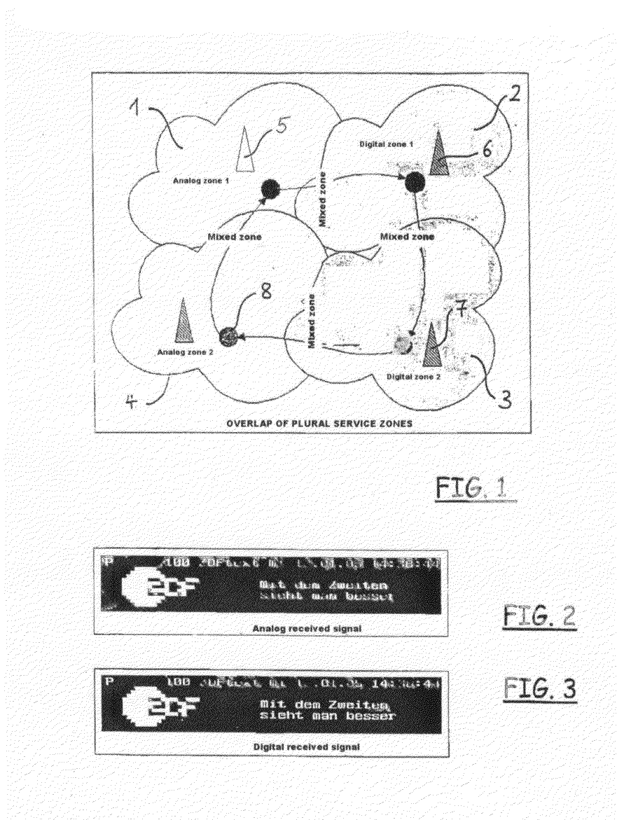

FIG. 1 shows various transmitters in various broadcast zones;

FIGS. 2 and 3 show the switch from one transmitter to another transmitter having the same program content;

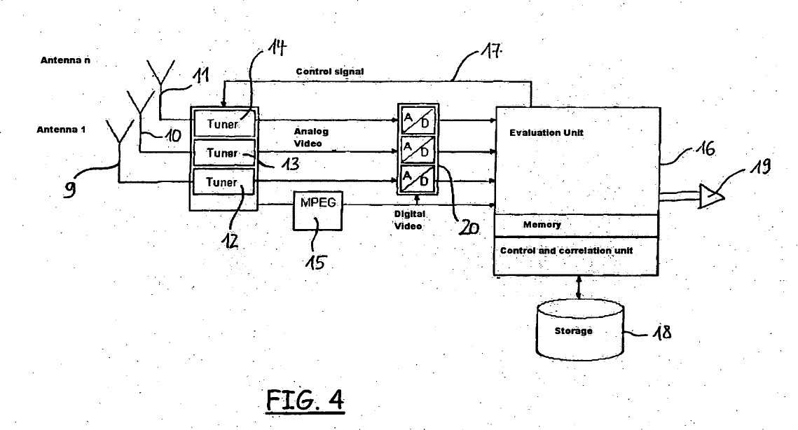

FIG. 4 shows an apparatus for performing the method.

FIG. 1 shows an example of a broadcast region comprising zones through which a vehicle is moving. Initially it is assumed that the vehicle is located for instance in an analog zone 1. Further along in the travel it reaches a digital zone 2 so that here the invention assures that the program (e.g. the television program ZDF, hereinafter ZDF) is received in analog format in the analog zone 1, the program ZDF still being received during the transition to the digital zone 2, that is, the program content being retained, although reception is no longer analog but is instead digital. As the vehicle continues its travel, it moves out of the digital zone 2 into a digital zone 3, and the program ZDF should continue to be received, but from a different transmitter. As travel continues, the vehicle enters an analog zone 4, and again the program ZDF should continue to be received, although no longer in digital format but rather in analog format. Thus overall what the invention attains is that a program (in this case e.g. ZDF) broadcast by different stationary transmitters 5 through 8 can be received continuously, regardless of whether one of the transmitters 5 through 8 broadcasts the program in digital or in analog format. Thus the invention makes it possible to switch if the vehicle moves from the one zone (analog or digital zone) into another zone (analog or digital zone).

In order to make it possible that identical programs or program contents are retained during the transition from the one zone to the next zone, in particular those criteria cited in the patent claims are used, specifically the data content of the received signals. In addition to determining the data content using data from the blanking intervals, the name of the broadcast and received transmitter, EPG or SI data, it is inventively provided that the data content is also determined using the contents of a teletext message of a transmitter. Refer to FIGS. 2 and 3 for this, in which the transition from an analog zone to a digital zone is shown. As an example of this, the teletext message of the transmitter ZDF is shown. FIG. 2 shows reception of the teletext message from the transmitter ZDF in the analog reception mode, specifically as an excerpt for the purposes of better understanding. The data shown here are transferred with the high-frequency signals broadcast by the transmitters, specifically in the form of data that constitute data content. In accordance with the invention, certain data content that are shown in FIG. 2 is now examined and compared to data content shown in FIG. 3 and received by another antenna. If it is determined that the selected data content (for instance the text string “ZDF-text Mi 12.01.05” are in agreement, as is the case in FIGS. 2 and 3, there can be a switch from analog reception to digital reception. During the determination of criteria for the switch (that is, the data content), those contents are suitable that cannot be changed for the individual transmitters during the period of the potential switch. The period shown in FIGS. 2 and 3 (14:38:44) would not be suitable for a switch, since this data content logically changes continuously. Thus, this means that a unique identification of the program content (same as data content) is required for diversity between analog and digital programs and between a plurality of digital programs. The correlation of teletext contents as shown in FIGS. 2 and 3 and as described herein has the particular advantage that it can be used for all of the transitions that are shown in FIG. 1. This requires that the programs to be received are also broadcast with teletext. If this is not the case, the data content can be performed advantageously using additional data, as described above.

With regard to the receiving situation, the following applies alternatively or in addition to the foregoing description: there is not (just) one program on a (receiving) antenna and the other programs on the next antenna, but rather all antennas contribute to receiving current programs. Only for the comparison is one antenna (path) tuned to the comparison program (in the new broadcast zone). All antennas are then switched.

FIG. 4 shows an example of an apparatus for performing the inventive method. Reference number 9 indicates an antenna that is configured depending on the frequency ranges to be received and that is housed in an appropriate location in a vehicle. If only the antenna 9 is used, the method works in accordance with the features of patent claim 1, so that in this case there is no diversity system. If more than one antenna is used, that is, antennas 9 through 11 are used in accordance with FIG. 4 (or even more than three antennas, in general “n” antennas, where “n”≧1), this is a diversity system that works according to the features of patent claim 1 or also or alternatively in accordance with the features of patent claim 2. Corresponding receivers (tuners) 12 through 14 are downstream of each antenna 9 through 11, the output signals of the receivers (not just the data from the tuner 12) being fed to an MPEG decoder. Its output signals are sent via a corresponding line to an evaluation unit 16 that has a logic unit embodied for performing the method, a results memory, and a control and correlation unit. In this case, if a plurality of antennas 9 through 11 and associated receivers 12 through 14 are provided, this is a diversity system so that for selecting any antenna 9 through 11 the evaluation unit 16 sends control signals via control lines 17 to the receiver unit, which goes through the signal paths from the antenna to the evaluation unit 16 in which there is the best possible reception.

In this embodiment the output signal of the MPEG decoder 15 is also provided to the AD converter. This is necessary and reasonable because the output signal of the MPEG decoder 15 in this case is (but does not have to be) an FBAS signal, that is, it is analog and thus must be converted from analog to digital format. Alternatively or in addition, a path from the MPEG decoder 15 directly to the evaluation unit 16 is conceivable.

Finally, the evaluation unit 16 also includes at least one output 19 (analog and/or digital) in order to be able to reproduce the signals (audio and/or video signals) that have been received and then processed by the antennas 9 through 11.

Finally, switched in the signal path from the receivers 12 through 14 to the evaluation unit 16 are analog/digital converters that make available the analog signals provided by the receivers 12 through 14 into the digital signals for further processing in the evaluation unit 16. The analog/digital converters can be provided separately between the receivers 12 through 14 and the evaluation unit 16, or alternatively they can also be integrated into the receivers 12 through 14 and/or the evaluation unit 16.

### REFERENCE LIST

1 A first analog zone
2 A first digital zone
3 Another digital zone
4 Another analog zone
5 Transmitter
6 Transmitter
7 Transmitter
8 Transmitter
9 Antenna
10 Antenna
11 Antenna
12 Receiver (tuner)
13 Receiver (tuner)
14 Receiver (tuner)
15 MPEG decoder
16 Evaluation unit
17 Signal line
18 Memory unit
19 Output
20 Analog/digital converter

1. A method for receiving high-frequency signals, where one antenna or a plurality of antennas of a receiver receives or receive the signals and those signals of an antenna that represent a pre-selectable program content are forwarded to a receiver, where necessary furthermore at least one other antenna being selectable that receives the signals with the same program content but better signal properties wherein the signals-received from the at least one antenna are examined for their data content and there is a switch from one signal received with the antenna to another signal received with the antenna if the data content of the one signal corresponds to the data content of the other signal.

2. The method in accordance with claim 1 wherein the signals received by the at least two antennas are examined for their data content and there is a switch from a signal received with the One antenna to a different signal received with the at least one other antenna if the data content of the one signal received with the one antenna corresponds to the data content of the other signal received with the other antenna.

3. The method in accordance with claim 1 wherein the data content is determined using data from the in particular vertical blanking interval (VBI, vertical blanking interval).

4. The method in accordance with claim 1 wherein the data content is determined using contents of a teletext message of a transmitter.

5. The method in accordance with claim 1 wherein the data content is determined using the name of the broadcast and received transmitter.

6. The method in accordance with claim 1 wherein the data content is determined using EPG data (electronic program guide data).

7. The method in accordance with claim 1 wherein the data content is determined using SI data (service information data).

8. The method in accordance with claim 1 wherein the data content is determined using PSI data (program specific information).

9. The method characterized by a combination of at least two determinations of the data content in accordance with claim 3.

10. An apparatus characterized by its embodiment and suitability for performing the method in accordance with claim 1.
